(19) United States
(12) Patent Application Publication
(10) Pub. No.: US 2018/0050564 A1
(43) Pub. Date: Feb. 22, 2018

(54) HUB AND HUB SERIES

(71) Applicant: DT SWISS INC., Grand Junction, CO (US)

(72) Inventors: Martin WALTHERT, Aarberg (CH); Stefan SPAHR, Lengnau (CH)

(21) Appl. No.: 15/677,896

(22) Filed: Aug. 15, 2017

(30) Foreign Application Priority Data
Aug. 22, 2016 (DE) 102016115515.2

(51) Int. Cl. B60B 27/00; B60B 27/02; F16C 19/18

(52) U.S. Cl. CPC B60B 27/0078; B60B 27/023; B60B 27/0005; F16C 2326/02; B60B 2900/111; B60B 2380/12; F16C 19/18

(57) ABSTRACT

A hub and a hub series are provided for at least partially muscle-powered bicycles. The hub includes a hub shell and a bearing unit for rotatably supporting the hub shell relative to an axle. The bearing unit includes two bearing rings having a take-up surface each and a raceway each. A bearing ring configured as an outer ring is oriented with its take-up surface to a bearing seat of the hub shell. A bearing ring configured as an inner ring is oriented with its take-up surface to the axle. Rolling members are disposed between the raceways of the bearing rings. The bearing ring includes a cut-out on its take-up surface for weight reduction so that the bearing ring is disposed spaced apart from the bearing seat and/or the axle in the region of the cut-out.

### BACKGROUND

The present invention relates to a hub and a hub series comprising at least two different hub types for at least partially muscle-powered bicycles.

In the area of sports and also in competitive sports, bicycle components are required which as a rule are particularly lightweight while also being very sturdy. Of particular significance are the wheels since optimized, reduced weight has particular consequences due to the rotary components. Therefore, high-quality wheels tend to consist of particular lightweight while also sturdy hubs and rims and spokes. The weight of hubs tends to be reduced by employing lightweight materials for the hub shell and the axle. Axles also tend to be hollow.

However, the roller bearings usually employed in hubs have a very high weight. Moreover, several of these bearings tend to be integrated in a hub. Rear wheel hubs may for example be provided with four roller bearings. Thus, the total weight of a hub is largely determined by the weight of the bearings employed. In the case of high-performance hubs, this is particularly decisive since the bearings form a particularly high proportion of the total weight.

The hubs must not bend in operation. Therefore, and because of the permanent loads and stresses, bicycle hubs tend to comprise roller bearings where both the bearing cups and the rolling members are manufactured from steel. Thus, these bearings have a high weight. Nevertheless, these components show the required stability. In the prior art and for example in motor sports, reduced-weight roller bearings have been disclosed consisting entirely or partially of ceramic material. The drawback is, however, that these roller bearings are very cost-intensive components. Moreover, the engineering strength of these roller bearings tends to be limited so that they require frequent replacing. These components are thus not suitable as mass products.

It is therefore the object of the present invention to provide a reduced-weight hub which at the same time allows particularly economic manufacturing, and which in particular does not involve any restriction regarding the engineering strength respectively does not increase the scope of maintenance.

### SUMMARY

The inventive hub is provided for at least partially muscle-powered bicycles. The hub comprises a hub shell and at least one bearing unit to rotatably support the hub shell relative to an axle. The bearing unit comprises at least two bearing rings. The bearing rings comprise at least one take-up surface each and at least one raceway each. A bearing ring, in particular an outer ring, is aligned with at least one bearing seat of the hub shell by its take-up surface. A bearing ring, in particular an inner ring, is aligned with the axle by its take-up surface. Rolling members are disposed for rolling off between the raceways of the bearing rings. At least one bearing ring shows at least one cut-out on its take-up surface in particular for weight reduction. A first solution consists in disposing the cut-out particularly preferably axially spaced apart from a(n axial) center of the raceway. According to a second solution, the cut-out may include the central area of the raceway wherein at least one balancing member is disposed in the cut-out at least in the region of the center of the raceway which member complements the cut-out take-up surface of the bearing ring relative to the bearing seat and/or the axle, the balancing member consisting of a material that is as hard as the bearing ring material. In these two configurations, the cut-out of the bearing ring in the region of the cut-out is disposed (radially or in the radial direction) spaced apart relative to the bearing seat and/or the axle so as to achieve a weight reduction of the bearing ring while maintaining substantially similar and in particular identical size of fit or toleranced dimensions of the bearing unit.

The inventive hub offers many advantages. It is a considerable advantage that the hub is particularly lightweight, its weight being considerably reduced over hubs having conventional bearing units. Moreover, the hub is particularly cost-effective in manufacture. Also, this lightweight construction does not show any drawbacks as regards the engineering strength. The optimized weight can be obtained by way of a structurally simple while also true-to-size configuration of the bearing units with cut-outs. The fact that no cut-out is formed in the center of the raceway in the bearing ring provides the full wall thickness of the bearing ring for supporting the bearing. Hubs of bicycles are subjected to extreme loads and stresses. The rotational force acting on the freewheel of a rear wheel hub may reach 400 Nm. This level of rotational forces may also occur in very high-powered motor vehicles. However, their stressed components show much larger dimensions so that the loads and stresses in bicycle hubs may in places exceed those in sports cars. Moreover, further loads and stresses may be acting on the hub and the bearing units for example during cornering. On the whole, bicycle hubs for the area of sports and professional uses require ensuring that even high loads and stresses do not ensue in inadmissible bending. This is ensured among other things by the fact that the raceway preferably does not include any void or hollow cut-outs which might result in insufficient support of the bearing unit. The axial center of the raceway or the alignment of the rolling members shows the full wall thickness. The full wall thickness may be provided by the bearing ring itself, or the full wall thickness is realized by a balancing member which consists, at least in the central region or in the center of the raceway, of a material that is as hard as the material of the bearing ring. This ensures that no bending will take place even if high and extreme loads and stresses occur. A ring of a ceramic material or the like may for example be employed. A ceramic ring is sufficiently hard and thus does not make contact with the rolling members so as to enable a long service life and low wear and tear combined with a low weight.

Preferably, at least one bearing unit comprises spherical rolling members.

Preferably, the or at least one cut-out formed in a bearing ring is disposed axially entirely outside the raceway of the bearing ring. This means that these cut-outs are located in the axial direction not inside the planes formed by the guide groove edges which are preferably configured in the raceway.

Preferably, the cut-out extends over at least 1/10 and in particular at least ⅛ and preferably at least ⅙ or ⅕ of a(n axial) width of the bearing ring. Two or more cut-outs may be provided in a bearing ring. In particular, at least one cut-out is provided on each of the axial sides of the bearing ring.

Preferably, the sum of all the surfaces of all the cut-outs in a bearing ring amounts to at least 1/10 and in particular at least ⅛ and preferably at least ⅕ or ¼ or even ⅓ of the cross-sectional area of the (remaining) bearing ring.

A supporting section is in particular formed in or at the axial center of the raceway in or on the bearing race where (at least) one cut-out follows on both sides. The supporting section may be configured separately and may consist e.g. of steel and/or ceramics etc.

Preferably (at least) one stem is configured as a support in at least one axially outwardly region of the bearing ring. In this way, the width of the bearing unit support is retained the largest possible so as to keep any bending loads down. The stem may also be a separate component, consisting of steel and/or ceramics etc.

Particularly preferably, the or at least one cut-out is void. This offers a particularly noticeable weight reduction. The cut-out is in particular configured as a void space or hollow space. The hub shows a void space in particular in the region of the cut-out.

It is likewise particularly preferred for at least one balancing member to be disposed in the region of the cut-out. The balancing member is in particular suitable and configured to complement the cut-out take-up surface fittingly or in an accurate fit relative to the bearing seat and/or the axle. It is also possible for the cut out to form a hollow space which is partially enclosed by a bearing ring.

Preferably, the balancing member is formed of a material weighing less than the bearing ring.

This configuration of the bearing units with cut-outs and balancing members disposed therein from a lightweight material provides a low weight combined with a reliable seat. For example, cost-effective standard bearing components may be employed which are then equipped with cut-outs and balancing members.

The cut-out is preferably disposed external of a section of the take-up surface opposite the raceway. This allows achievement of considerable weight reduction combined with a particularly robust and rigid raceway. No cut-out is in particular disposed in the section of the take-up surface opposite the raceway. The bearing ring in particular shows the full wall thickness in the section of the take-up surface opposite the raceway. A raceway is in all the cases in particular considered to be a depression worked into the bearing ring for receiving and/or guiding the rolling members.

The section opposite the raceway is in particular aligned with the raceway. The cut-out is in particular disposed outside of alignment with the raceway. The alignment with the raceway in particular includes no cut-out or else a cut-out fittingly filled up with a hard material.

The section opposite the raceway preferably shows the same width as the raceway. In particular, the section opposite the raceway shows the same width as do the rolling members rolling off the raceway. The width of the rolling members in particular refers to their maximum width and/or their maximum diameter or their mean width and/or mean diameter.

The cut-out extends in particular over at least one tenth and preferably at least one fourth of the cross-sectional area of the bearing ring. The cut-out may also extend over at least one eighth and preferably over at least one sixth and particularly preferably over at least one third of the cross-sectional area of the bearing ring. It has been shown that these extensions of the cut-out offer a particularly advantageous relationship of weight reduction versus stability. The cut-out may also extend over more or less than the cross-sectional area of the bearing ring.

The bearing ring is preferably integral or one piece. The bearing ring is in particular manufactured from a steel material. The bearing ring for example consists of a roller bearing steel and/or another steel alloy suitable for roller bearings. Alternately, the bearing ring may be configured of another metal material. The bearing ring in particular consists of one material only. These bearing rings are particularly suitable for use in the inventive hub since they are very stable and sturdy while they are also comparatively cost-effective components. Moreover, working the cut-out into these bearing rings is simple. Alternately, it is possible for the bearing ring to be formed of two or more material components, consisting for example of a hybrid material.

The balancing member is preferably made of plastic. Alternately, the balancing member may be partially or entirely made of a fibrous composite material. The balancing member is in particular one piece. The balancing member may also be made of a different material which is in particular more lightweight than the bearing ring material. The cut-out is preferably disposed in a bearing ring made of roller bearing steel and fittingly balanced by means of a balancing member of plastic. Plastic balancing members have a clearly lower weight than the cut-out bearing ring material and they are robust and cost-effective.

It is also possible for the balancing member to consist at least partially or substantially entirely of a foamed material or to comprise at least one foamed material. The balancing member may contain at least one hollow space that is filled in particular with a fluid and preferably a gas. Configurations where the balancing member comprises a foamed material may provide for the walls of the hollow spaces or of the pores to consist of heavier materials. It is also possible for the balancing member to comprise a hollow space or multiple hollow spaces. For example, an annular balancing member having a (thin) wall and a hollow space partially or entirely surrounded by the wall is conceivable.

In a preferred configuration, the hub shell and in particular the bearing seat is configured to receive a bearing unit having at least one standardized size of fit or toleranced dimension. The balancing member is preferably suitable and configured to restore the bearing unit back to the standardized size of fit. This configuration allows a combination of particularly cost-effective and proven standard elements with the balancing member. The hub preferably also comprises at least one axle which can be received in a bearing unit having a standardized size of fit. It is preferred for the bearing ring together with the balancing member to provide a take-up surface showing a standardized size of fit.

The bearing ring may comprise at least one circumferential cut-out. The balancing member is in particular annular. An open or closed ring may be provided. The annular balancing member is in particular received in the circumferential cut-out. This configuration is structurally simple while also providing considerable saving on weight. Moreover, this configuration provides for the balancing member to be permanently and reliably accommodated in the cut-out even if high bearing forces are applied. A cut-out and/or the balancing member is/are for example and preferably configured in an annularly cylindrical shape.

The cut-out is in particular disposed on at least one edge section of the bearing ring. It is also possible and preferred for the cut-out to be disposed on at least one central section of the bearing ring. Alternately, a continuous cut-out may be provided. The cut-out may extend over the entire take-up surface. Then, the cut-out extends for example over the two edge sections and the central section. The cut-out in particular extends at least partially over an outside surface of the outer ring and/or over an inside surface of the inner ring. Alternately, the cut-out may extend only over one edge section and the central section. Alternately, it is possible for the cut-out to be configured in two opposite edge regions of the bearing ring. Then, the cut-outs are preferably disposed symmetrically opposite and/or mirrored on a circumferential center line of the bearing ring. In the case of one or multiple cut-outs in a central region, the cut-outs are in particular laterally enclosed by at least two edge sections. Cut-outs so disposed show a particularly favorable influence on the stability of the bearing ring since the material of the bearing ring serves as a support in the edge regions.

Particularly preferably, the bearing ring and the balancing member disposed in the cut-out together show a substantially annularly cylindrical contour. The annularly cylindrical contour may be discontinuous in sections. The contour may for example be provided conical on the raceways. The bearing ring together with the balancing member disposed in the cut-out in particular comprises an annularly cylindrical contour on the radial face and the adjacent axial side sections.

The bearing ring in particular shows an annularly cylindrical contour which is broken by the cut-out and which is restored by the balancing member. This contour allows a particularly stable and reliable seat of the bearing rings. It is possible for the annularly cylindrical contour to show at least one rounding at least on one edge and/or corner, for example a chamfer. Alternately, it is possible for the annularly cylindrical contour to show at least one groove and/or at least one beveled edge or the like. Alternately, it is possible for the bearing ring together with the balancing member disposed in the cut-out to show another contour suitable for bearing cups of roller bearings.

In a particularly preferred configuration, the balancing member has at least one cross-sectional area which is configured triangular or quadrangular or polygonal. The cross-sectional area may also be round or oval or curve-shaped in contour. This cross-sectional area shows the advantage that the balancing member is simple in manufacturing and it can be disposed in the cut-out. It is possible for the balancing member to show rounded edges and/or corners. Then the cross-sectional area preferably also shows rounded corners.

The cross-sectional area of the balancing member in particular corresponds to a negative shape of a cross-sectional area of the cut-out. The cross-sectional area of the cut-out in particular ensues from the areas of the take-up surface missing out of a provided fit. The cross-sectional area of the balancing member is in particular configured so that the balancing member can be accommodated in the cut-out without play respectively in a tight fit. The balancing member in particular fills the entire cut-out.

In all the configurations, it is preferred for the bearing rings of a bearing unit to be equipped with balancing members showing different cross-sectional areas. The advantage thereof is that the balancing members can be optimally adapted to the conditions for the inner ring and the outer ring which differ as a rule. Preferably, the outer ring and the inner ring are provided with different balancing members. The outer and inner rings are in particular provided with balancing members showing different cross-sectional areas. Due to the arrangement of the inner ring inside the outer ring the bearing rings show in particular different diameters. The balancing members for the outer ring and the inner ring may be configured for a size of fit involving different tolerances. This is particularly advantageous for compensating different manufacturing tolerances of the hub shell and the axle.

For example, the cross-sectional areas of the balancing members differ in at least one side length. For example, the balancing member of a bearing ring may show a wider and/or longer cross-sectional area than does the balancing member of the other of the bearing rings of the bearing unit. It is also preferred for the balancing members of the bearing rings to differ in their body volumes, being configured for example larger or smaller. Preferably, the pertaining cut-outs for the balancing members of the bearing rings of a bearing unit also show different cross-sectional areas respectively body volumes. Alternately, it is possible for the bearing rings of a bearing unit to show identical cross-sectional areas.

Also, different numbers of balancing members may be provided for the bearing rings of a bearing unit. For example, the inner ring may have a larger or smaller number of balancing members than the outer ring. Accordingly, the number of cut-outs is matched to the number of balancing members.

Particularly preferably, the balancing member is flush-mounted in the cut-out. The balancing member provides, in particular together with the bearing ring, a flush-mounted and/or continuous area for the take-up surface. The balancing member is in particular disposed in the cut-out so as to not project beyond a plane of the bearing ring respectively of the take-up surface. The balancing member is preferably disposed flush-mounted relative to radial and/or axial sections of the take-up surface. In particular, are the annularly cylindrical contours of the bearing ring and the balancing member configured flush-mounted. These flush arrangements of the balancing member allow a reliable and loadable seat of the bearing ring in the hub shell or of the axle in the inner ring respectively.

In all the configurations, it is preferred for the balancing member to be disposed contacting the bearing seat of the hub shell or the axle. When the hub is in the mounted state, a balancing member disposed on the inner ring is in particular disposed contacting the axle and/or the bearing seat. A balancing member of the outer ring is in particular disposed contacting the bearing seat. Such arrangement of the balancing members supports the seat of the bearing unit particularly advantageously without play.

It is preferred for the cut-out to vary the diameter and/or the width of the bearing ring at least in sections. The cut-out may also reduce the diameter over the entire width of the bearing ring. In particular, does the cut-out at least in sections reduce the outer diameter of the outer ring. In particular, the cut-out at least in sections, reduce the inner diameter of the inner ring. The cut-out preferably reduces the width of the bearing ring at least in sections.

The balancing member is preferably suitable and configured to restore the diameter changed by the cut-out and/or the width changed by the cut-out to once again be fitting relative to the bearing seat and/or the axle. This allows considerable reduction of the weight of the bearing unit while at the same time maintaining the required size of fit, the cut-outs notwithstanding. The balancing member in particular enlarges the outer diameter of the outer ring in the region of the cut-out. The balancing member in particular reduces the inner diameter of the inner ring. The balancing member preferably enlarges the width of the bearing ring.

In an advantageous specific embodiment, the balancing member shows at least one oversize dimension relative to the bearing seat and/or the axle prior to mounting the hub. The balancing member is preferably suitable and configured to adapt to a size of fit of the bearing seat and/or the axle when the hub is in the mounted state. Thus, the balancing member can adapt to the bearing seat respectively the axle during mounting. This bearing unit may, for example be installed in more roughly toleranced bearing seats. This offers a particularly economic manufacturing of the hub and in particular the hub shell respectively the axle. The balancing member is in particular disposed on the bearing seat and/or the axle by means of interference fit.

Preferably, the balancing member is configured elastic at least in part. The balancing member is in particular manufactured from an elastic and/or flexible material. This allows simple and fast mounting of the balancing member on the bearing ring. For example, an annular balancing member can simply be pulled onto the bearing ring. An oversized elastic balancing member is moreover particularly well suited to adapt to a size of fit of the bearing seat and/or the axle in the mounted state of the hub.

The inventive hub series comprises at least two different hub types for at least partially muscle-powered bicycles. The hub series comprises at least one first hub type and at least one second, differing hub type. Each hub of each hub type comprises a hub shell and at least one bearing seat and at least one bearing unit exchangeably accommodated on the bearing seat to rotatably support the hub shell relative to an axle. The first hub type comprises a bearing unit of a first bearing type. The second hub type comprises a bearing unit of a second bearing type. A bearing unit of the first bearing type and a bearing unit of the second bearing type substantially show the same size of fit and in particular an identical size of fit. The bearing units of the first bearing type and the second bearing type differ in at least one essential bearing property. The substantial bearing property is in particular the weight and/or a tolerance and/or a seal. The inventive hub series in particular comprises at least one hub and preferably multiple hubs, as it has been described above.

The inventive hub series also offers many advantages. The hub series shows the considerable advantage that the bearing units of the two bearing types show identical or similar size of fit but differences in the substantial bearing property and in particular in the weight.

For example, the hub series comprises, other than a lightweight construction variant, also a variant including a cost-reduced bearing unit. This allows for example, a cost-oriented taking up of bicycle sports, wherein firstly a low-cost high-performance hub is used with a bearing unit of the second bearing type. This hub can then at a later time be further enhanced as regards the weight and other essential bearing properties by simple and uncomplicated substitution of the first bearing type for the second bearing type. The inventive hub series thus allows a particularly cost-effective access to high-quality lightweight hubs.

The bearing units of the first and second bearing types preferably comprise substantially the same size of fit and, in particular identical size of fit. The bearing units of the first and second bearing types differ in particular as regards the inner structure and/or the materials employed. The bearing units of the first and second bearing types differ in particular as regards the bearing rings and in particular as regards the weight of the bearing rings. It is also possible for the first and second bearing types to have different sealing devices for shielding against moisture and dirt. It is also possible for the differences to relate to the rolling members of the bearing units. This provides advantageous influences on particularly essential bearing properties.

Each bearing unit of the first and second bearing types in particular comprises at least two bearing rings each having least one take-up surface and at least one raceway each. At least one bearing ring of the at least two bearing rings, in particular an outer ring, is in particular configured for alignment with the bearing seat of the hub shell by its take-up surface. At least one bearing ring of the at least two bearing rings, in particular an inner ring, is in particular configured for alignment with the axle and/or the bearing seat by its take-up surface. Rolling members are disposed for rolling off between the raceways of the bearing rings of a bearing unit. These roller bearings are particularly suitable to be used in the hubs of the hub series since they offer reliable bearing properties and they are also cost-effective.

A bearing unit of the second bearing type particularly preferably comprises at least one bearing ring which is configured fitting and preferably precisely fitting relative to the bearing seat and/or the axle. The bearing ring of the second bearing type in particular does not include a cut-out. This allows to achieve defined fitting of the bearing unit without using balancing members. The bearing ring is in particular configured integrally. The bearing ring is in particular manufactured of one material only and in particular of a steel alloy and for example roller bearing steel. Both the bearing rings, the inner ring and the outer ring, of the second bearing type are in particular so configured. This second bearing type offers the advantage that hubs equipped therewith allow cost-effective access to the hub series.

A bearing unit of the first bearing type particularly preferably comprises at least one bearing ring with at least one cut-out in its take-up surface. The cut-out causes the bearing ring to be disposed in the region of the cut-out spaced apart from the bearing seat and/or the axle.

In the region of the cut-out, at least one balancing member is in particular disposed at least in sections. The balancing member is preferably suitable and configured to restore the fit of the cut-out take-up surface relative to the bearing seat and/or the axle.

Preferably, the bearing unit of the first bearing type is configured as was described above for the inventive hub. In particular, both the bearing rings, the inner ring and the outer ring, of the first bearing type are so configured. This allows equipping of the hub series with hubs which offer the advantages of the inventive hub.

Preferably, the balancing member is formed of a material weighing less than the bearing ring. This allows a considerable reduction of the weight of hub types of the hub series, since the bearing units as a rule contribute to a large portion of the total weight of the hub.

It is preferred for the raceways of the bearing rings of the bearing units of the first and second bearing types to be formed of a steel material. These raceways are particularly durable and correspondingly the manufacturing the bearing rings is cost-effective. It is also possible to manufacture the raceways from other materials. It is possible for the bearing rings of the first and second bearing types to differ in the materials of their raceways.

In all the configurations of the hub series, it is preferred for at least a considerable portion of the hub shell, and in particular the entire hub shell, to be formed of a light metal and/or a lightweight material. These hub shells offer a low weight combined with high stability. For example, the hub shell may be formed of an aluminum alloy and/or a fibrous composite material. It is possible for the hub shell to consist of both a light metal and a fibrous composite material. It is possible for the hub shells of the two hub types to be identical in configuration. Alternately, it is possible for the hub shells of the hub types to differ in configuration.

The size of fit relates in particular to the fitting dimension or mounting dimension of the outer ring relative to the bearing seat and/or a dimension of the inner ring relative to the accommodated axle. The size of fit in particular describes a diameter and/or a width of the bearing rings. The balancing member complements the cut-out take-up surface, in particular in a precise fit according to the fitting of the bearing unit, bearing seat and axle required for the hub.

The take-up surface is in particular the region of the bearing ring which in the mounted state is in contact with the bearing seat respectively the accommodated axle. The take-up surface is in particular disposed on the radially outside surface of the outer ring and/or on the radially inside surface of the inner ring. Alternately, the take-up surface may be disposed on at least one axial side section of the bearing ring.

The raceways are in particular disposed on at least one section of the outer ring inner face and inner ring outer face.

In the scope of the present invention, the hub shell also comprises at least one rotor. This is the case in particular if the hub is a rear wheel hub respectively drive hub. In the scope of the present invention, the bearing seat of the hub shell is then also understood to mean the bearing seat of the rotor. The rotor is preferably rotatably supported relative to a hub sleeve of the hub shell.

### BRIEF DESCRIPTION OF THE DRAWINGS

Further advantages and features of the present invention can be taken from the exemplary embodiments which will be described below with reference to the enclosed figures.

The figures show in:

FIG. 1 a schematic side view of a bicycle;

FIG. 2 a schematic side view of another bicycle;

FIG. 3 a schematic illustration of a hub according to the invention in a sectional view;

FIG. 4 a schematic illustration of another hub in a sectional view;

FIGS. 5 to 9 simplistic illustrations of various configurations of bearing units of a bearing type; and

FIG. 10 a simplistic illustration of a bearing unit of another bearing type.

### DETAILED DESCRIPTION

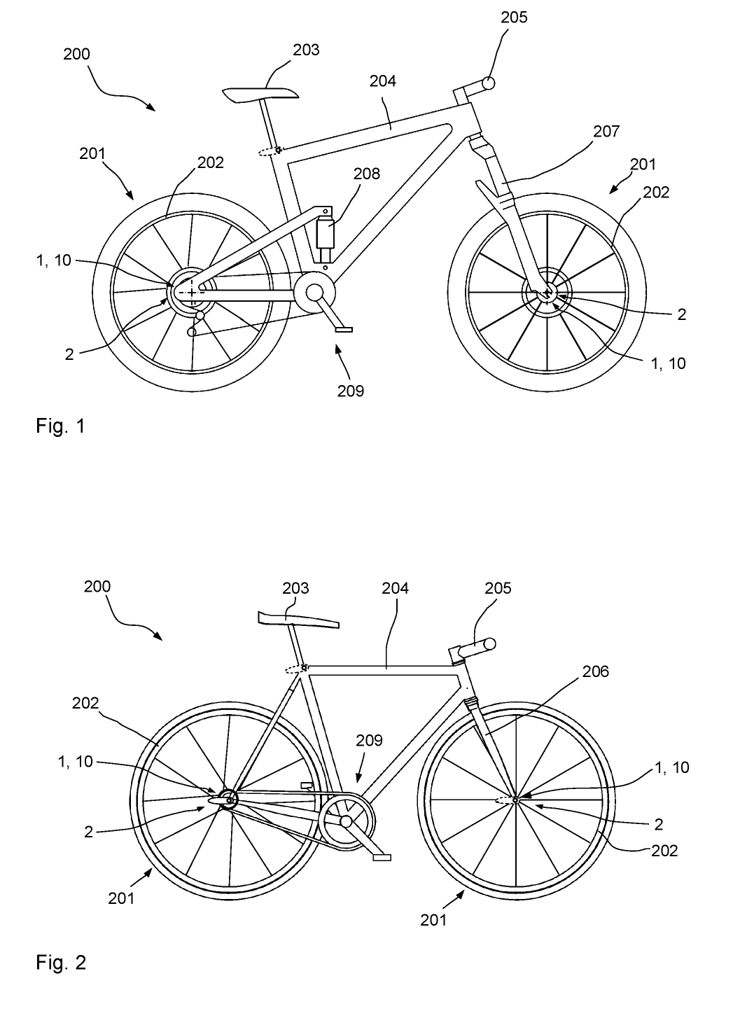

FIG. 1 shows a simplistic illustration of a bicycle 200 which is configured as a mountain bike. The bicycle 200 may also be configured as a partially muscle-powered two-wheeled vehicle and for example an E-bike.

The bicycle 200 comprises two wheels 201 which are respectively equipped with a hub 1, 10 and a rim 202. The hubs 1, 10 may correspond to different hub types 12, 22. The bicycle 200 is a full suspension bicycle. The fork is a suspension fork 207 and the frame 204 is provided with a rear wheel damper 208.

Furthermore, the bicycle 200 comprises a saddle 203, a frame 204, a handlebar 205 and a fork 206, and further bicycle components. This bicycle 200 comprises a chain-shifting device or derailleur as part of a pedal drive 209. For a derailleur the hub 1, 10 may for example comprise a rotor which can accommodate individual sprockets or a cassette respectively.

The bicycle 200 further comprises a brake device not shown in detail. To this end the hubs 1, 10 of the two wheels 201 may be provided with a brake accommodation each to non-rotatably mount a brake disk. The wheels 201 configured as a front wheel and a rear wheel are each attached to dropouts of the fork 207 respectively the frame 204.

FIG. 2 shows a bicycle 200 configured as a racing bicycle, respectively a roadster. This bicycle 200 also comprises two wheels 201, each having a hub 1, 10 and a rim 202. The hubs 1, 10 (for the front wheel and the rear wheel) may each correspond to different hub types 12, 22 (for the front wheel and the rear wheel). Moreover, the bicycle 200 comprises a saddle 203, a frame 204, a handlebar 205, and a rigid fork 206, and a pedal drive 209.

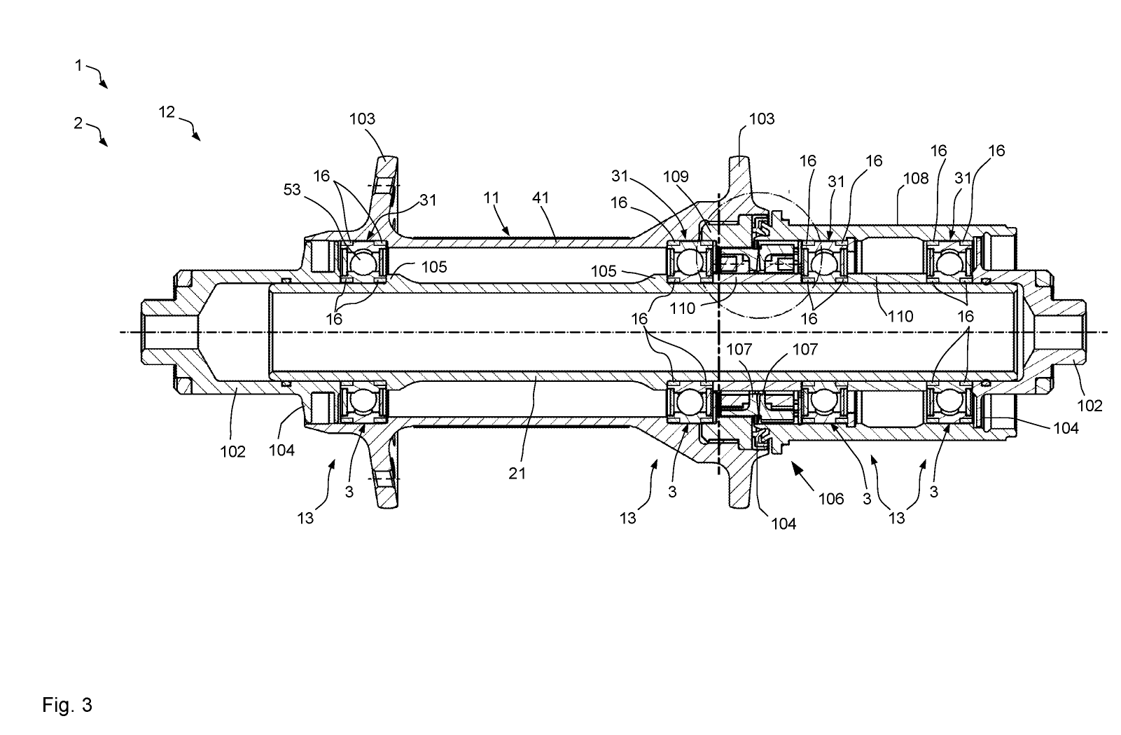

FIG. 3 shows an inventive hub 1, presently a rear wheel hub. A hub may correspondingly be configured as a front wheel hub. This hub 1 comprises a hub shell 11 having a hub sleeve 41 and a rotor 108. The hub sleeve 41 comprises two spoke flanges 103 for receiving spokes so that the hub 1 may be disposed in a wheel 201.

This hub shell 11 comprises bearing seats 31 for receiving four bearing units 3 with rolling members 53. Two bearing units 3 are disposed in the hub sleeve 41 so as to support it rotatably relative to an axle 21. This rotor 108 is rotatably supported relative to the axle 21 by means of a pair of bearing units 3. As a rule, a corresponding front wheel hub only shows two bearing units 3 in the hub sleeve 41.

A freewheel device 106 is disposed between the rotor device 108 and the hub sleeve 41 which allows rotatability of the rotor 108 relative to the hub sleeve 41 in one direction only. In the other direction of rotation, the freewheel device 106 comes into engagement so that the rotor 108 drives the hub sleeve 41 for joint rotation.

This rotor 108 is configured to receive at least one sprocket and in particular a plurality of sprockets or a cassette respectively. Thus, a rotary motion of the rotor 108 may be initiated by means of a chain and the pedal drive 109 of a bicycle 200. When the freewheel device 106 is engaged, the hub sleeve 41 and thus the entire wheel 201 are also caused to rotate. In freewheeling, the hub sleeve 41 and the entire wheel 201 can rotate independently of the rotor 108 so that the bicycle 200 can roll independently of the pedal drive 209.

This freewheel device 106 comprises two toothed disks 107 having an axial toothing each. When the freewheel device 106 is in engagement, the teeth intermesh so that the toothed disks 107 transmit the driving torque to the hub sleeve 41. During freewheeling, the toothed disks 107 disengage so that the rotor 108 and the hub sleeve 41 can rotate independently.

To ensure reliable engagement of the toothed disks 107, a biasing device, not shown in detail, is provided which biases the toothed disks 107 relative to one another. The biasing device may in particular comprise one or two e.g. floating biasing units such as coil springs or other biasing units. To transmit the rotational force one of the toothed disks 107 is received non-rotatably relative to the rotor 108 and the other of the toothed disks 107 is received non-rotatably relative to the hub sleeve 41. The hub sleeve 41 comprises a threaded ring 109, presently screwed in, in which the toothed disk 107 is inserted non-rotatably.

The axle 21 comprises two circumferential shoulders 105 which prevent axial displacement of the axle 21 within the hub shell 11. To this end, the shoulders 105 each rest against one of the two bearing units 3 of the hub sleeve 41.

The bearing units 3 for supporting the rotor 108 are spaced apart by means of a spacer sleeve 110. The adjacent bearing units 3 of the hub sleeve 41 and the rotor 8 likewise show defined distances from one another by way of a spacer sleeve 110.

An adapter ring 102 is disposed on each of the two axial ends of the axle 21. The adapter rings 102 serve to adapt the diameter of the axle 21 to the dropouts of the bicycle 200. The adapter rings 102 are preferably plugged on and can be pulled off the axle 21 without tools. The adapter rings 102 are for example retained on the axle 21 by means of a circumferential O-ring. When the hub 1 is installed, the adapter rings 102 are then retained by the bias applied.

Alternately, the hub 1 may be equipped with an axle 21 which can be received in the dropouts without any adapter rings 102. Then, for example a through axle is passed through the axle 21 and attached to the dropouts.

These adapter rings 102 are configured with a circumferential seal 104. The seals 104 prevent the entry of dirt and moisture into the hub 1. Moreover, another seal 104 is disposed between the rotor 108 and the hub sleeve 41. This seal 104 is preferably configured as, or comprises, a labyrinth seal.

Alternately, the inventive hub 1 may be equipped with another type of freewheel device 106. For example, a ratchet freewheel may be provided. It is also possible and preferred for the inventive hub 1 to be configured as a drive hub without a freewheel device 106.

Alternately, the inventive hub 1 may be configured as a hub 1 without drive or rotor 108, and it may, for example be configured as a front wheel hub. In this configuration the hub shell 11 preferably only comprises the hub sleeve 41 but no rotor 108. Moreover, the hub 1 then preferably comprises two bearing units 3 only by way of which the hub sleeve 41 is supported rotatable relative to an axle 21. Alternately, the hub 1 may be equipped with five or six or more bearing units 3, for example in the case of a tandem or an E-bike.

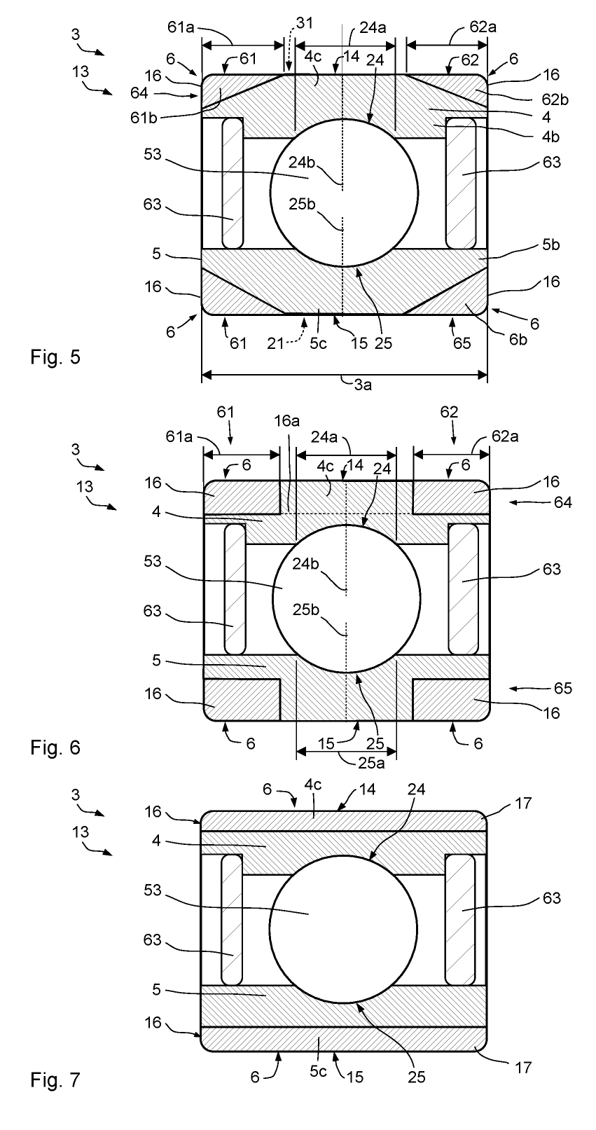

For an advantageous weight reduction of the hub 1, the bearing units 3 are provided with cut-outs 6 in which preferably hollow spaces are configured or balancing members 16 preferably of plastic are disposed. The balancing members 16 provide for the desired fitting between the bearing units 3 and the bearing seat 31 respectively the axle 21 which would otherwise show a distance, which may be undesirable, in the region of the cut-outs 6. The bearing unit 3 with cut-outs 6 and balancing members 16 will now be described in detail with reference to the FIGS. 5 to 9.

The FIGS. 5 to 9 illustrate configurations of the bearing units 3 as they may for example be used in the inventive hub 1.

The bearing units 3 in the FIGS. 5 to 9 are illustrated in section so that the cross-sectional areas of each of the bearing rings 4, 5 and the cross-sectional areas of the pertaining cut-outs 6 or balancing members 16 are particularly clearly shown. The cross-sectional areas are hatched. It is thus particularly clearly shown how far a cut-out 6 or a balancing member 16 extends over a cross-sectional area of the bearing ring 4, 5.

The bearing unit 3 in the FIGS. 5 to 9 comprises two bearing rings 4, 5 each, which are configured as an outer ring 4 and an inner ring 5. In the mounted state the outer ring 4 is received in a bearing seat 31 of a hub shell 11, not shown, see also FIG. 3. The inner ring 5 likewise comprises a take-up surface 15 which is disposed on the axle 21, not shown (see FIG. 3).

Rolling members 53 are disposed between the bearing rings 4, 5 which in this case are balls. A spacer and, for example, a cage may be disposed between each of the rolling members 53. Each of the bearing rings 4, 5 comprises a raceway 24, 25 for the rolling members 53 to roll off. The raceways may be configured as guide grooves. The raceway 24 of the outer ring 4 is disposed on the inside surface and the raceway 25 of the inner ring 5, on the outside surface. These bearing rings 4, 5 are manufactured for example integrally and of a roller bearing steel. The bearing units are preferably deep-groove ball bearings.

The axial side faces of the bearing unit 3 are provided with a sealing member 63 each to prevent the entry of moisture and dirt. Further sealing members may be provided, which are not shown. It is also possible for the bearing unit 3 to comprise one sealing member 63 only or no sealing member 63 at all.

The bearing rings 4, 5 are each provided with a number of cut-outs 6. On the radially outwardly peripheral surface of the outer ring 4 and on the radially inwardly peripheral surface of the inner ring 5, pairs of cut-outs 6 are configured namely, in the orientation of the drawing one left cut-out 61 and one right cut-out 62 in the outer and inner rings 4, 5. In another view, two inner cut-outs 65 are formed in the inner ring 5 and two outer cut-outs 64, in the outer ring 4 (one each on the right and left).

When the bearing unit 3 is mounted, the bearing ring 4, 5 is distanced relative to the bearing seat 31 or the axle 21 in the region of the cut-outs 6. Therefore, each of the cut-outs is filled with one balancing member 16 each. This restores the take-up surface 14, 15 back to a size of fit which the bearing unit 3 would show without the cut-outs 16 and which allows a precisely fitting bearing seat.

The balancing members 16 are disposed flush-mounted with the cut-outs 6. Thus, the balancing members 16 combined with the pertaining bearing ring 4, 5 provide a flush-mounted and continuous take-up surface 14, 15. The balancing members 16 complement the cut-outs 6 so that the bearing rings 4, 5 show a substantially annularly cylindrical contour.

The balancing members 16 may be connected with the bearing rings 4, 5 for example in a form-fit and/or force-fit and/or by adhesive bond. The balancing members 16 may for example be press-bonded and/or glue-bonded with the bearing rings 4, 5. The balancing members 16 may also be elastic in configuration and may be pulled onto the bearing rings 4, 5.

The balancing members 16 are preferably also employed for tolerance compensation, and they may be oversized prior to mounting. The mounting then preferably involves an interference fit.

Working cut-outs 6 into the comparatively heavy bearing rings 4, 5 and then inserting lighter balancing members 16 achieves considerable weight reduction of the bearing units 3. The precisely fitted matching of the take-up surfaces 14, 15 by way of the balancing members 16 offer the particular advantage of these weight-reduced bearing units 3 that they may be assembled in the same way as are comparable bearing units having no cut-outs 6 and e.g. standard bearings. These balancing members 16 are manufactured from a material that is lighter than the bearing rings 4, 5 and for example from plastic.

The bearing units 3 shown comprise in particular a standardized size of fit which is achieved by complementing the cut-out regions 6 with the balancing members 16. The balancing members 16 thus complement the take-up surface in the region of the cut-outs 6 so as to obtain the standardized size of fit, the cut-outs 6 notwithstanding.

The cut-outs 6 shown in the FIG. 5 are circumferentially disposed on the bearing rings 4, 5. The cut-outs 6 of a bearing ring 4, 5 are disposed on its opposite edge sections. No cut-out 6 is provided in a central section lying in-between. The axial center 24b of the raceway 24 is also located in the axial center of the bearing unit 3. The bearing unit 3 according to FIG. 5 does not show any cut-out 6 over the entire width 24a of the raceway 24. A supporting section 4c is configured to ensure a high-precision positioning of the bearing unit 3. Even if high bending moments occur it is ensured that the bearing ring 5 is not locally deformed in the region of the contact surfaces of the rolling members 53. This is important since even minor bending may cause major stability problems in particular in a rear wheel hub. It has been found that a supporting section 5c in the region of the raceway 25 or even over the entire width 25a of the raceway 25 is very advantageous.

Accordingly, a supporting section 4c is provided, preferably in the region of the outer ring 4, in the region of the center 24b of the raceway 24 or even over the entire width 24a of the raceway 24. This prevents undesirable and detrimental bending of the bearing unit 3 and the hub 1. At the same time, cut-outs 6 may be configured in adjacent regions of the bearing ring 4 respectively 5, configured as void spaces or hollow spaces or filled or equipped with a balancing member. The supporting sections 4c and 5c may be manufactured as separate components e.g. from a ceramic material or else may be manufactured integrally with the bearing rings 4, 5. Both cases ensure reliability of operation. It is important for the bearing units 3 to not yield much in the region of the raceways.

Two outer cut-outs 64 are configured in the outer ring 4 namely, a left cut-out 61 on the left end and a right cut-out 62, which is presently symmetric, on the right end.

Two inner cut-outs 65 are configured in the inner ring 5 namely, a left cut-out 61 on the left end and a right cut-out 62, which is presently symmetric, on the right end.

The supporting sections 4c, 5c are formed in the central region and a plane transverse to the axle through the center of the raceway 24b and/or through the center of the raceway 25b respectively the rolling surfaces intersects the supporting sections 4c and/or 5c.

The cut-outs 61 and 62 in the outer ring 4 each extend over an axial width 61a respectively 62a which is preferably larger than ¼ or ⅕ of the bearing width 3a. A surface proportion of the cut-outs 61 and 62 in the outer ring 4 in the cross-sectional area 4b of the part (e.g. integral and in particular consisting of steel) of the outer ring 4 is larger than 1/12 and in particular larger than 1/10 and in the configuration according to FIG. 5 it may achieve or exceed a total of ⅛ or ⅙. This applies accordingly to the cut-outs 61 and 62 in the inner ring 5. On the whole, the use of void or hollow spaces or employing balancing members 16 of a lightweight plastic allows saving considerable weight, involving no loss as to quality, function, and service life.

In FIG. 5, the balancing members 16 disposed in the cut-outs 6 show a substantially triangular cross-sectional area. Since the circumferential balancing members 16 have a flattened edge or chamfer, a corner of the cross-sectional triangle is correspondingly configured flattened.

The cut-outs 6 cause changes to the diameter and the width of the bearing rings 4, 5 in the region of the cut-outs 6. The balancing members 16 then restore the width and diameter of the bearing rings 4, 5 back to the original, optionally required, size of fit.

FIG. 6 shows a bearing unit 3 comprising balancing members 16 having a substantially quadrangular cross-sectional area. The balancing members each show an annularly cylindrical contour. The outwardly exposed edge is rounded or chamfered so that a corner of the cross-sectional area is also correspondingly rounded. This allows saving much weight, since a larger surface area or a larger volume is removed. In the region of the centers 24b respectively 25b or of the alignment of the raceway 24 or 25, the bearing unit 3 from FIG. 6 also shows (lug-type) supporting sections 4c or 5c which provide for reliable support and prevent even minimal bending.

A broken line in FIG. 6 shows a separation line 16a indicating that the supporting sections 4c respectively 5c may be configured separately and then they are not formed of one single, integral material with the pertaining bearing ring. The supporting sections 4c respectively 5c then consist of a stable and hard material which is at least as hard as the steel of the bearing ring between the supporting section and the rolling member. For example, the supporting section may consist at least partially or entirely of at least one type of ceramic. The supporting section 4c respectively 5c may e.g. be press-bonded and/or glue-bonded with the bearing ring 4 respectively 5. Although this configuration does not decrease the stability under load and durability of the bearing unit, the weight is noticeably reduced. The standardized dimensions of the bearing unit may on the whole be maintained.

Since the rotating speeds in operation—including in high bicycle traveling speeds—remain relatively low compared to many industrial applications, the bearing units 3 generate relatively little heat which can be reliably dissipated through the hub. Therefore, there will be no overheating of the hub 1 and the bearing units 3 due to the operational speed. In the region of the raceways, the roller bearings do not require any expansion spaces which may in particular even be detrimental to the operating performance. In the region of the respective centers 24b and 25b of the raceways 24 and 25, supporting sections 4c and 5c of stable materials are therefore preferred which are in particular manufactured integrally with the pertaining bearing ring 4, 5.

In the configuration according to FIG. 6 and also in the other configurations and exemplary embodiments the balancing member 16 or at least one balancing member 16 may comprise at least one hollow space. The balancing member 16 may for example consist of, or comprise, a foamed material showing (microscopically) small hollow spaces which according to the illustration in FIG. 6 may be that small that they cannot reasonably be illustrated in FIG. 6. Alternately, it is possible for a balancing member 16 to comprise an outer wall and an inner hollow space.

FIG. 7 shows a bearing unit 3 where the bearing rings 4, 5 each show a continuous cut-out 6. The cut-out 6 extends both over the edge sections and over the central section. The cut-out 6 of the outer ring 4 thus reduces the diameter of the outer ring 4 so that it has a certain play relative to the bearing seat 31 of the hub shell 11. A balancing member 16 showing an annularly cylindrical configuration restores the outer diameter of the outer ring 4 to the required size of fit. The balancing member 16 at the outer ring 4 is formed of a ceramic ring 17 or a ring of a ceramic material.

Thus, the ceramic ring 17 provides a supporting section 4c. There is no risk of bending since there is no hollow space in the central section in the region of the raceway 24. The material of the balancing member 16 is sufficiently strong while showing low weight.

The inner ring is constructed accordingly. The inner diameter of the inner ring 5 was increased by the cut-out so as to provide for play relative to the accommodated axle 21. The balancing member 16, which is again configured as an annular cylinder, in the shape of a ceramic ring 17 restores the inner ring to the diameter required for the size of fit. Thus, the inner ring 5 and the axle 21 can be mounted with the desired fitting. An undesirable bending is reliably prevented.

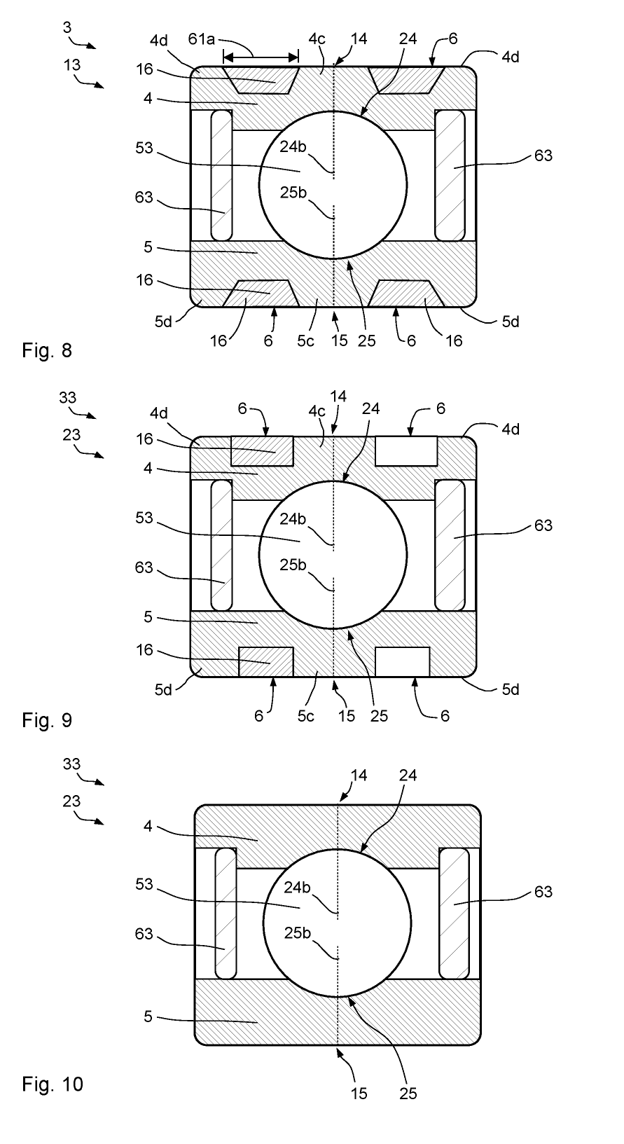

FIG. 8 shows a bearing unit 3 with complex shapes of cut-outs 6 on the inner ring 5 and outer ring 4. The cut-out 6 is not disposed in a central section of the bearing rings 4, 5. These cut-outs 6 have been supplemented with balancing members 16 until the desired size of fit was obtained. The balancing members 16 show a polygonal cross-sectional area. Moreover, the cross-sectional area may also comprise curve-shaped regions. Also, in the exemplary embodiment according to FIG. 8 at least one balancing member 16 may comprise at least one hollow space.

The cut-outs 6 may show both straight and curve-shaped sections. A curve-shaped section is preferably matched to the contour of the raceways 24, 25 so that no material is cut out in the region of the raceways 24, 25. This is advantageous since particularly high forces act on the bearing rings 4, 5 in the region of the raceways 24, 25. Thus, a suitable quantity of material may be removed from the bearing rings 4, 5 for weight reduction for one, and for another a sufficient quantity of material remains for reliable stability. Moreover, this allows improvement of the damping characteristics of the bearing unit 3 so that riding is more comfortable and/or the bearing unit 3 is treated with care.

FIG. 9 shows a bearing unit 3 with pairs of cut-outs 6 for the inner ring 5 and the outer ring 4 disposed in a central section. Thus, sufficient material remains between the cut-outs 6 in the region of the raceways 24, 25. A supporting section 4c respectively 5c for a reliable support remains in the pertaining center 24b respectively 25b of the raceways 24 respectively 25.

The cut-outs 6 for the inner ring 5 and outer ring 4 disposed on the right are configured void. The hub 3 equipped with such a bearing unit 3 therefore comprises void spaces respectively hollow spaces in the region of the cut-outs 6. In a configuration, the cut-outs 6 on the left may be void. The configurations shown in the other Figures may also be equipped with void or hollow cut-outs. FIG. 9 shows at the ends on the right and left of the bearing unit 3 supporting webs respectively stems 4d and 5d on the outer ring 4 and the inner ring 5 which ensure a still further enhanced lateral support. Thus, the bearing unit 3 has a broad support and comprises supporting sections 4c and 5c in the central region and in-between e.g. void spaces in the cut-outs 6 which allow saving considerable weight.

The cut-outs 6 shown in the FIGS. 5 to 9 may be equipped without any balancing members 16 in specific embodiments. Then, the cut-outs 6 in which no balancing members 16 are disposed preferably remain void. In these configurations, the hatched regions indicated at the reference numeral 16 then correspond to the void cut-outs 6.

The void cut-outs 6 are preferably disposed such that the bearing unit 3 shows a required size of fit relative to the bearing seat 31 respectively the axle 21 even without a balancing member 16 inserted. This configuration is exemplarily shown in the FIGS. 8 and 9.

The balancing members 16 shown in the FIGS. 5 to 9 may be interchanged on the various bearing units 3 in any random useful combination and quantities. The cut-outs 6 are then adapted to the contour respectively cross-sectional area of the pertaining balancing members 16 so that the desired size of fit is obtained.

In particular, are both the bearing rings 4, 5 provided with at least one cut-out 6 each and preferably also with at least one balancing member 16 each. Alternately, only one of the bearing rings 4, 5 may be provided with a cut-out or two or more cut-outs 6 and/or balancing members 16.

For example, balancing members 16 having a quadrangular cross-sectional area may be disposed in an edge section of a bearing ring 4, 5 and balancing members 16 having a triangular cross-sectional area may be disposed in an opposite edge section.

The balancing members 16 of a bearing ring 4, 5 may be different or similar in configuration. Balancing members may be provided for the inner ring 5 and the outer ring 4 showing different configurations of the cross-sectional areas or else similar cross-sectional areas.

For example, the FIGS. 5 and 6 show bearing units 3 whose cross-sectional areas of the balancing members 16 for the inner ring 4 show larger side lengths than do the cross-sectional areas of the balancing members 16 for the outer ring 4.

Alternately, the cross-sectional areas of the balancing members for the inner ring 5 and the outer ring 4 may show substantially the same side lengths as is, for example shown in FIG. 7.

The inventive hub series 2 may for example be employed in the bicycles 200 of FIGS. 1 and 2. The bicycles 200 may be equipped with a hub 1 of a first hub type 12 or a hub 10 of a second hub type 22 of the hub series 2. The hub types 12, 22 differ in their bearing units 3, 33.

The hub 1 shown in FIG. 3 represents a first hub type 12 of the hub series 2. This hub type 12 shows bearing units 3 of a first bearing type 13 which is e.g. illustrated in FIG. 6. This first bearing type 13 comprises the bearing units 3 described for the hub 1 according to the invention. This bearing type 13 is described in more detail with reference to the FIGS. 5 to 9.

It may be provided that the hub 1 comprises both bearing units 3 of the first bearing type 13 and also bearing units 33 of the second bearing type 23. For example, only the bearing units 3 for supporting the hub sleeve 41 may correspond to the first bearing type 13. The other bearing units 33 for supporting the rotor 108 may then for example correspond to the second bearing type 23.

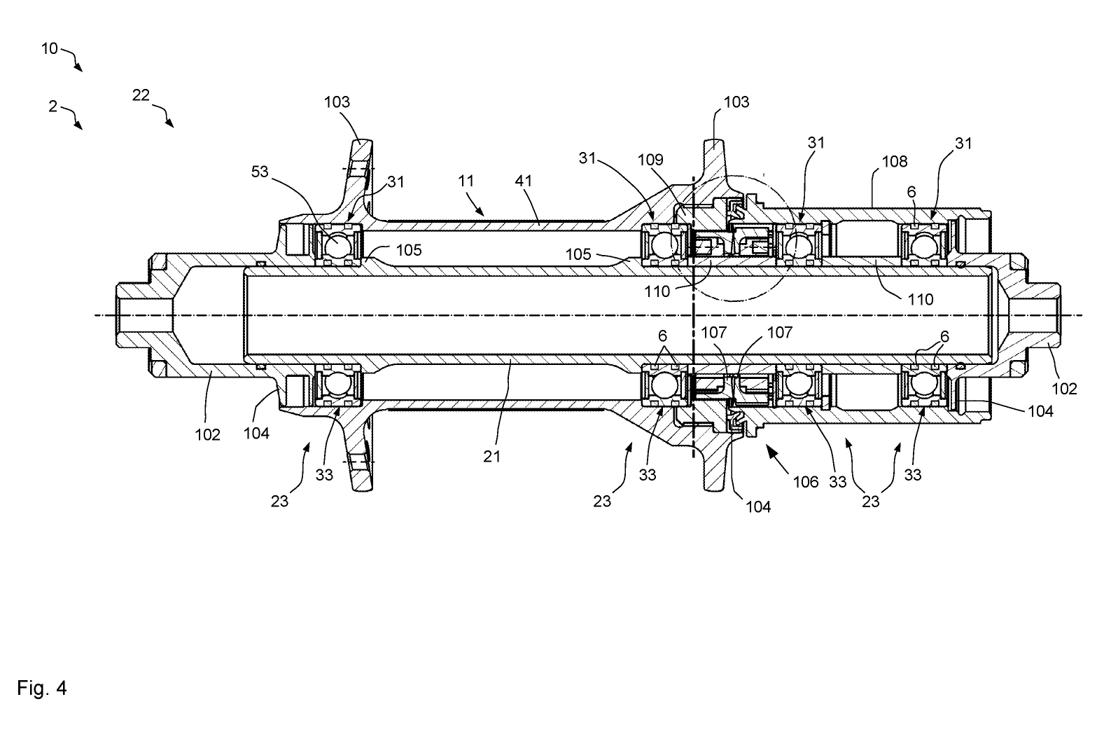

FIG. 4 shows a hub 10 of the second hub type 22 of the hub series 2 with a bearing unit 33 of a second bearing type 23 which is shown in more detail e.g. in FIG. 8. Alternately, it is possible to employ a bearing unit 33 as it is shown in the FIG. 10 and which represents another second bearing type 23 or e.g. a third bearing type. The hub series may comprise many hubs which differ in particular only or substantially by the (exchangeable) bearing units respectively bearing types used.

Basically, the FIGS. 5 to 10 each show an independent bearing type, all of which having the same fitting dimension and size of fit and which are thus interchangeable.

FIG. 10 shows a bearing unit 33 pertaining to the second or another bearing type 23 and comprising the same size of fit as do the bearing units 3 of the first bearing type 13 illustrated in the FIGS. 5 to 9. The bearing unit 33 shown comprises in particular a standardized size of fit.

However, the bearing unit 33 in FIG. 10 does not show any cut-outs 6 in the region of the take-up surfaces 14, 15 of the outer ring 4 or the inner ring 5. Thus, this bearing unit 33 has a considerably higher weight than the previously described bearing units 3 of the first bearing type 13.

The hub 10 shown in FIG. 4 is identical in construction with the hub 1 shown in FIG. 3, with the exception of the bearing units 33. FIG. 4 illustrates bearing units from FIG. 9. Using bearing units from the FIGS. 6, 7, 8 and in particular FIG. 10 is likewise possible though, since all the bearing units of the FIGS. 5 to 10 show the same fitting dimensions.

The bearing units 3, 33 have the same size of fit. Accordingly, the accommodations for the bearing units 3, 33 in the hubs 1, 10 are configured the same. Thus the bearing units 3, 33 can be interchanged between the two hubs 1, 10 of the two hub types 12, 22 of the hub series 2.

To this end the bearing units 3, 33 are preferably provided for exchanging without tools. Particularly preferably the illustrated hubs 1, 10 are also provided for no-tools dismantling. To this end, for example the adapter rings 102 may be pulled off the axle 21. Thereafter, the rotor 108 can be pulled off respectively separated from the hub sleeve 41. Then, the axle 21 can be pulled out of the hub sleeve 41. Now all the bearing units 3, 33 are accessible and ready to be exchanged.

The bearing units 3, 33 of the two or more bearing types 13, 23 differ in at least one substantial bearing property, showing identical size of fit. Thus, the bearing units 3, 33 are interchangeable as desired within the hub series 2 so as to equip the hubs 1, 10 with the required respectively desired bearing properties.

For example, the bearing units 3 of the first bearing type 13 show a considerably lower weight although their dimensions are the same, due to the cut-outs and the balancing members 16. Since the bearing units 3, 33 usually considerably contribute to the total weight of the hub 1, 10, exchanging can advantageously influence the weight of the hub.

Thus, a beginner may start out with a low-cost hub 10 of the second hub type 22 with bearing units from FIG. 10. He may then replace at a later time the hub 10 by a hub 1 of the first hub type 12. He may for example exchange the bearing unit 33 of the second bearing type 23 by a bearing unit 3 of the first bearing type 13. This allows a particularly cost-effective and simple weight reduction of the hub 1, 10.

In manufacturing, a bearing unit 3 is for example equipped with a standardized size of fit showing at least one cut-out 6 in the bearing rings 4, 5. The cut-out 6 is then restored to the standardized size of fit by at least one balancing member 16 of a more lightweight material than that of the bearing ring 4, 5. Thus the bearing unit 3 may be used again as a standard element while also offering considerably saving on weight relative to conventional bearings.

While particular embodiments of the present hub and hub series have been described herein, it will be appreciated by those skilled in the art that changes and modifications may be made thereto without departing from the invention in its broader aspects and as set forth in the following claims.

List of reference numerals:

| | |
|---|---|
| 1 | hub |
| 2 | hub series |
| 3 | bearing unit |
| 3a | bearing width |
| 4 | bearing ring, outer ring |
| 4a | width |
| 4b | cross-sectional area |
| 4c | supporting section |
| 4d | stem |
| 5 | bearing ring, inner ring |
| 5a | width |
| 5b | cross-sectional area |
| 5c | supporting section |
| 5d | stem |
| 6 | cut-out |
| 6a | width |
| 6b | area |
| 10 | hub |
| 11 | hub shell |
| 12 | first hub type |
| 13 | first bearing type |
| 14 | take-up surface |
| 15 | take-up surface |
| 16 | balancing member |
| 16a | separation line |
| 17 | ceramic ring |
| 21 | axle |
| 22 | second hub type |
| 23 | second bearing type |
| 24 | raceway |
| 24a | width |
| 24b | raceway center, alignment |
| 25 | raceway |
| 25a | width |
| 25b | raceway center, alignment |
| 31 | bearing seat |
| 33 | bearing unit |
| 41 | hub sleeve |
| 53 | rolling member |
| 61 | left cut-out |
| 61a | width |
| 61b | area |
| 62 | right cut-out |
| 62a | width |
| 62b | area |
| 63 | sealing member |
| 64 | outer cut-out |
| 65 | inner cut-out |
| 102 | adapter ring |
| 103 | spoke flange |
| 104 | seal |
| 105 | shoulder |
| 106 | freewheel device |
| 107 | toothed disk |
| 108 | rotor |
| 109 | threaded ring |
| 110 | spacer sleeve |
| 200 | bicycle |
| 201 | wheel |
| 202 | rim |
| 203 | saddle |
| 204 | frame |
| 205 | handlebar |
| 206 | fork |
| 207 | suspension fork |
| 208 | damper |
| 209 | pedal drive |

1. A hub for at least partially muscle-powered bicycles with a hub shell and with at least one bearing unit to rotatably support the hub shell relative to an axle, the bearing unit comprising:
at least two bearing rings with at least one take-up surface each and at least one raceway each; wherein a bearing ring configured as an outer ring is oriented with its take-up surface to at least one bearing seat of the hub shell; wherein a bearing ring configured as an inner ring is oriented with its take-up surface to the axle; wherein rolling members are disposed for rolling off between the raceways of the bearing rings; at least one bearing ring comprises a cut-out on its take-up surface, so that the bearing ring is disposed in the region of the cut-out radially spaced apart from the bearing seat and/or the axle, so that a weight reduction of the bearing ring is obtained while substantially maintaining the size of fit of the bearing unit, and that the cut-out is disposed axially spaced apart from a center of the raceway;
and/or
the cut-out includes the area of the center of the raceway and that at least one balancing member is disposed in the cut-out at least in the region of the center of the raceway which member complements the cut out take-up surface of the bearing ring fittingly relative to the bearing seat and/or the axle; and said balancing member consists of a material that is as hard as or harder than the material of the bearing ring.

2. The hub according to claim 1, wherein the cut-out configured in a bearing ring is disposed axially entirely outwardly of the raceway of the bearing ring.

3. The hub according to claim 1, wherein the cut-out extends over at least 1/10 or at least ⅙ of a width of the bearing ring.

4. The hub according to claim 1, wherein the sum of all the surfaces of all the cut-outs in a bearing ring amounts to at least 1/10 or at least ⅕ of the cross-sectional area of the bearing ring.

5. The hub according to claim 1, wherein a supporting section is configured in the axial center of the raceway in the bearing race where one cut-out each follows on both sides.

6. The hub according to claim 5, wherein the supporting section is integrally formed with the bearing ring or is formed by a balancing member of a material that is as hard as the material of the bearing ring.

7. The hub according to claim 6, wherein a stem is configured as a support in at least one axially outwardly region of the bearing ring.

8. The hub according to claim 1, wherein at least one balancing member is disposed in the region of the cut-out consisting of a material that is lighter than the material of the bearing ring, which complements the cut-out take-up surface fittingly relative to the bearing seat and/or the axle.

9. The hub according to claim 1, wherein the bearing seat is configured to receive a bearing unit having at least one standardized size of fit and wherein the balancing member is suitable and configured to restore the bearing unit to the standardized size of fit.

10. The hub according to claim 1, wherein the bearing ring comprises at least one circumferential cut-out and wherein the balancing member is annular in configuration.

11. The hub according to claim 1, wherein the bearing ring together with the balancing member disposed in the cut-out is substantially annularly cylindrical in contour.

12. The hub according to claim 1, wherein balancing members having different cross-sectional areas are disposed on the bearing rings of a bearing unit.

13. The hub according to claim 1, wherein the balancing member is disposed flush-mounted in the cut-out.

14. The hub according to claim 1, wherein the cut-out changes the diameter and/or the width of the bearing ring and wherein the balancing member restores the diameter and/or the width to once again fit relative to the bearing seat and/or the axle.

15. The hub according to claim 1, wherein the balancing member shows at least one oversize dimension relative to the bearing seat and/or the axle prior to mounting the hub and wherein the balancing member is suitable and configured to adapt to a size of fit of the bearing seat and/or the axle in the mounted state of the hub.

16. The hub according to claim 1, wherein the cut-out is disposed on at least one edge section of the bearing ring.

17. The hub according to claim 1, wherein the bearing ring is formed integrally and in particular of a steel material.

18. The hub according to claim 1, wherein the or at least one cut-out is void.

19. A hub series comprising: at least two different hub types for at least partially muscle-powered bicycles, comprising at least one first hub type and at least one second, differing hub type; wherein each hub of each hub type comprises a hub shell and at least one bearing seat and at least one bearing unit exchangeably accommodated on the bearing seat to rotatably support the hub shell relative to an axle; and wherein the first hub type comprises a bearing unit of a first bearing type and the second hub type comprises a bearing unit of a second bearing type; a bearing unit of the first bearing type and a bearing unit of the second bearing type substantially show the same size of fit and considerably differ in at least one substantial bearing property such as weight, tolerance, or seal.

20. The hub series according to claim 19, wherein a bearing unit of the first bearing type has a lower weight than a bearing unit of the second bearing type.

21. The hub series according to claim 19, wherein a considerable part of a bearing unit of the first bearing type consists of a material that is more lightweight than that of a bearing unit of the second bearing type.

22. The hub series according to claim 19, wherein the bearing units of the first and second bearing types show the same size of fit and differ in their inner structure and/or the materials employed.

23. The hub series according to claim 19, wherein each bearing unit of the first and second bearing types comprises at least two bearing rings each, having at least one take-up surface each and at least one raceway each, wherein a bearing ring, namely an outer ring, can be oriented with its take-up surface to the bearing seat of the hub shell and wherein a bearing ring, namely an inner ring, can be oriented with its take-up surface to the axle and wherein rolling members are disposed for rolling off between the raceways of the bearing rings.

24. The hub series according to claim 23, wherein a bearing unit of the second bearing type comprises at least one bearing ring which is configured fitting relative to the bearing seat and/or the axle.

25. The hub series according to claim 19, wherein a bearing unit of the first bearing type comprises at least one bearing ring having at least one cut-out on its take-up surface, so that the bearing ring is disposed in the region of the cut-out spaced apart from the bearing seat and/or the axle.

26. The hub series according to claim 25, wherein at least one balancing member is disposed at least in sections in the region of the cut-out which complements the cut-out take-up surface fittingly relative to the bearing seat and/or the axle.

27. The hub series according to claim 26, wherein the balancing member is formed of a more lightweight material than the bearing ring so that the bearing unit of the first bearing type shows the same size of fit while having a lower weight than the bearing unit of the second bearing type.

28. The hub series according to claim 23, wherein the raceways of the bearing rings of the bearing units of the first and second bearing types are formed of a steel material.
